(19) United States
(12) Patent Application Publication
(10) Pub. No.: US 2022/0114135 A1
(43) Pub. Date: Apr. 14, 2022

(54) COMPUTER ARCHITECTURE FOR ARTIFICIAL INTELLIGENCE AND RECONFIGURABLE HARDWARE

(71) Applicant: Mostafizur Rahman, Kansas City, MO (US)

(72) Inventor: Mostafizur Rahman, Kansas City, MO (US)

(21) Appl. No.: 17/481,285

(22) Filed: Sep. 21, 2021

Related U.S. Application Data
(60) Provisional application No. 63/081,280, filed on Sep. 21, 2020.

(51) Int. Cl. G06F 15/78; G06F 9/54

(52) U.S. Cl. CPC G06F 15/7867; G06F 9/546

(57) ABSTRACT

A reconfigurable computer architecture includes a reconfigurable chip. The reconfigurable chip includes learning computing blocks that are interconnected virtually. The learning computing blocks each store a source address and a destination address and communicate with one another using message passing.

### PRIORITY CLAIM

This patent application claims priority to earlier-filed Provisional Patent Application No. 63/081,280, filed on Sep. 21, 2020.

### TECHNICAL FIELD

This specification relates to the field of computer architectures.

### BACKGROUND

A von Neumann architecture, one of the early computer architectures, includes a central processing unit, memory, and input/output devices. The von Neumann architecture is based on the stored-program computer concept where instruction data and program data are stored in the same memory. The basic concept behind the von Neumann architecture is the ability to store program instructions in memory along with the data on which those instructions operate. Over time, however, computer architectures have evolved to deliver, for example, increases in performance and cost effectiveness.

Artificial intelligence is the idea of machines being able to carry out tasks without being explicitly programmed to do so and includes the broad concept of machines being able to carry out tasks in a way that would be considered smart. Machine learning is a subset of artificial intelligence that provides systems access to data and the ability to automatically learn and improve from experience. That is, performance improves as they are exposed to more data over time.

ASIC (i.e., application-specific integrated circuit), is an integrated circuit chip customized for particular use, rather than intended for general-purpose use. For example, it is a chip which serves the purpose for which it has been designed and cannot be reprogrammed or modified to perform another function or execute another application.

FPGA stands for field-programmable gate array. It is a hardware circuit that a user can program to carry out one or more logical operations. Those circuits, or arrays, are groups of programmable logic gates, memory, or other elements.

Further, ALU is an arithmetic logic unit. CPU stands for central processing unit. GPU stands for graphical processing unit. TPU stands for tensor processing unit. A VGGNET is a very deep convolutional network.

An Accelerator is a co-processor that sits with the CPU and is generally dedicated to speed up given tasks. AI accelerator refers to a special type of co-processors that accelerate machine learning tasks such as convolution, pooling and activation functions.

Scalability in an AI Accelerator domain refers to the capability to expand the integrated circuit to accommodate more components.

### SUMMARY

The details of one or more embodiments of the subject matter described in this specification are set forth in the accompanying drawings and the description below. Other features, aspects, and advantages of the subject matter will become apparent from the description, the drawings, and the claims.

Basic computer architecture includes the main components of a computer system, such as a processor, memory, input/output devices, communication channels, and instructions regarding how these components interact. Different architectures can be selected based on performance, reliability, efficiency, cost, etc.

The present disclosure is directed to a computer architecture supporting artificial intelligence, including deep neural networks, sorting and searching algorithms, genetic search, database fast query, machine learning, image processing, shading, video encoding/decoding, sorting, web search, data mining and sorting, high performance computing tasks to healthcare applications such as DNA search.

### BRIEF DESCRIPTION OF THE DRAWINGS

FIG. 1 depicts a chip overview and an engine, according to the present disclosure.

FIG. 2 depicts a diagram of resource mapping, according to the present disclosure.

FIG. 3 depicts an exemplary core, according to the present disclosure.

FIG. 4 depicts a matrix multiplication example, according to the present disclosure.

FIG. 5 depicts inputs and outputs of a SiteO, according to the present disclosure.

FIG. 6 illustrates message processing relative to SiteO, according to the present disclosure.

FIG. 7 depicts inputs and outputs of a SiteM, according to the present disclosure.

FIG. 8 illustrates message processing relative to SiteM.

FIG. 9 refers to one implementation of a Block where embedded memory interfacing is shown.

FIG. 10 shows a compiler framework to translate high level code to machine code.

Like reference numbers and designations in the various drawings indicate like element.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

Application-specific integrated circuits (ASICs) can provide more benefits compared to the generic CPUs for specific applications. The CPUs (GPUs likewise, which is a variant of CPU with Single Instruction Multiple Data architecture) would spend the majority of time fetching instruction and operand data from memory which are molded to run on the generic hardware, and hence are slower. It is impossible to have custom design for every possible application. A Probabilistic Magneto-Electric Computing Framework (PMEC) is a technology framework for implementing probabilistic reasoning functions. Hence, there is an on-going need to provide a configurable system to meet these high demand computing tasks.

The present disclosure is directed to an artificial intelligence (AI) accelerator card, or chip, that can be fitted in a server card slot to co-exist with a CPU (similar to how NVIDIA's graphics card fit in high-end servers). For AI tasks, the computational needs have increased.

The present disclosure is directed to a chip that can be reconfigured at run-time to behave as a custom-ASIC for each running AI application. It revolves around a unique flexible virtual interconnection scheme where any computing core (referenced as a Site) can be connected to another at run-time. In this scheme, a set of Sites are connected in 2-D grids (referenced as Tiles), and each Site can communicate with another site within and outside a Tile through message passing.

A message originating from site1 can hop several sites (e.g., site2, site3) before reaching destination site4. In this messaging scheme, once the source and destination addresses are set in Sites, it is as if virtual physical connections are made. By changing the destination address in a site, the virtual connection can be altered, which is the basis for mIPU's reconfigurability. Another aspect of configurability is the Sites are designed to handle different types of instructions (i.e., arithmetic, logic, comparison, etc.). The reconfigurability aspects are the foundations for benefits; it maximizes resource utilization and minimizes memory dependence. When m-IPU is configured, it is as if the hardware is being customized for the software that is running and the input is the same as the software's input (e.g., an image).

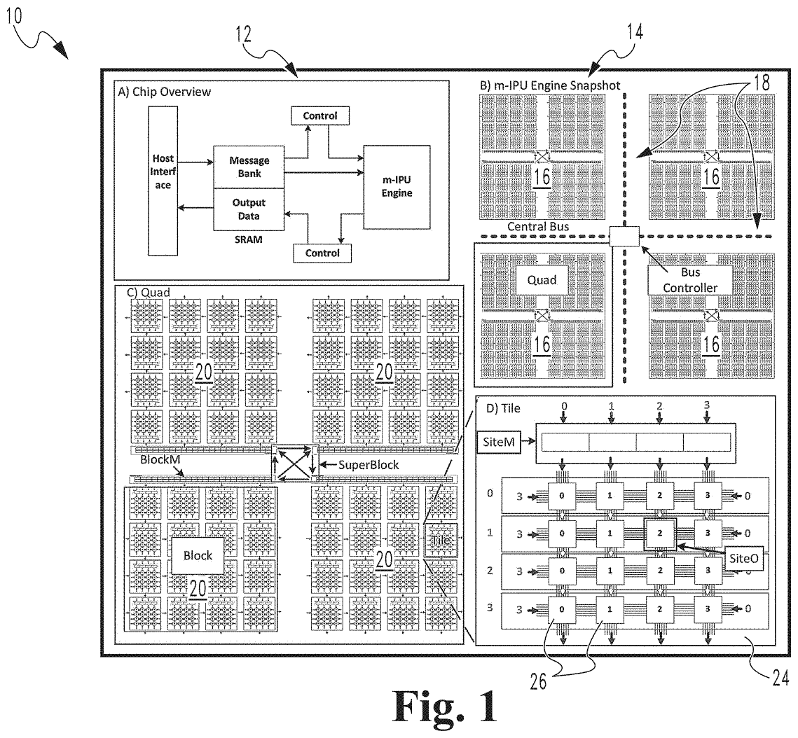

FIG. 1 depicts a block diagram (10) representing an overview of a chip (12) showing key components, according to the present disclosure. A snapshot of the m-IPU engine (14) shows 4 Quads (16) connected through a Bus (18). A larger chip (12) will have many Quads (16). A Quad (16) consists of 4 Blocks (20), the Blocks (20) are connected to each other through a Superblock (22), which enables point to point connectivity through a mailbox concept where each Block (20) has a dedicated mailbox. As shown, 16 Tiles (24) make a Block (20). Tiles (24) are made-up Sites (26), such as 16 SiteOs and 1 SiteM. In SiteOs, computation takes place and SiteM facilitates communication within and outside the Tile (24). The SiteOs are the core elements and are analogous to threads of GPUs or the Processing Elements (PEs) of TPUs. The hierarchy of Quads (16), Blocks (20), Tiles (24), and Sites (26) allows task distribution and parallel computing.

The chip (12) may be fitted in a server card slot and can co-exist with the CPU. The m-IPU engine (14) only needs to be interfaced with the memory to input instructions and output data through the memory to the outside world. A host CPU is required (similar to GPUs and other Accelerators) to interpret high-level language (e.g., C, Python, etc.) and translate them into messages that m-IPU can operate upon (inside the m-IPU all communication between computing and storage elements is through messages). The memory is an L1 cache segmented into message storage and output data sections. The control unit ensures that the messages and data are synchronized.

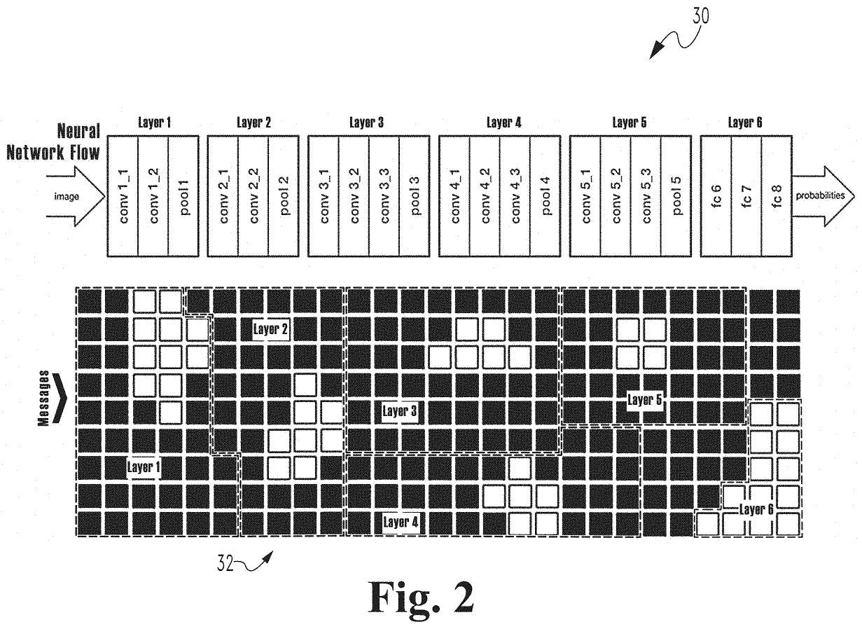

FIG. 2 depicts an engine 14 comprising a Quad processor, according to the present disclosure, and illustrating an m-IPU application mapping concept. As shown, each layer of a VGGNET (top) (30) being implemented in the m-IPU fabric (bottom) (32) and being interconnected. The information flows from left to right in a seamless manner without requiring much memory load/store activities.

According to the four-part processing model, recognizing words as meaningful entities requires communication among the phonological processor, orthographic processor, and meaning processor.

A Quad-core CPU has four processing cores in a single chip. It is similar to a dual-core CPU, but has four separate processors (rather than two), which can process instructions at the same time. Quad-core CPUs have become more popular in recent years as the clock speeds of processors have plateaued.

When referring to computer processors, quad-core is a technology that enables four complete processing units (cores) to run in parallel on a single chip. Having this many cores give the user virtually four times as much power in a single chip.

AI algorithms typically involve matrix manipulation for training and inference. The reconfigurability allows the morphing of Sites (26) according to the needs; an example of VGGNET implementation where each layer is mapped onto the m-IPU fabric (bottom) (32) and are virtually connected. Another direct benefit of reconfigurability is the reduction in load/store operations involving memory. In a CPU/GPU/TPU architecture, operands are first loaded from the memory, computation is done and the result is then stored back. If there are data dependencies between instructions, then parallel resources become useless.

For example, to perform the operation ((A*B)+C) in a single ALU, A and B are loaded from the memory first, then A*B is performed and the result is stored back; afterward, C and (A*B) are loaded from the memory, added using the ALU and stored back. These load/store operations are the primary reasons for performance lags and are reasons for >70% stalls of microprocessors. The GPUs or CPUs with TPU engine are often extensions of CPUs and incorporate Single Instruction Multiple Data (SIMD) architecture; fundamentally the Von-Neumann load/store bottleneck remains.

Through reconfiguration, similarity to custom hardware is achieved (e.g., as if the hardware is dedicated for ((A*B)+C) and only needs A, B, C loads in the beginning to produce the final result) and reduce load/stores. In the abstract VGGNET implementation (top) (20), we show that all layers can be mapped to the m-IPU fabric (bottom) (32), and there is no need to store the outcome of one layer (e.g., layer 1) to memory and then load again to compute results of another layer (e.g. layer 2). In m-IPU, all layers can be mapped, and the outputs of each layer can automatically stream to the next based on the configuration. The inputs are data inputs, weights, and filters as they are in the actual algorithm.

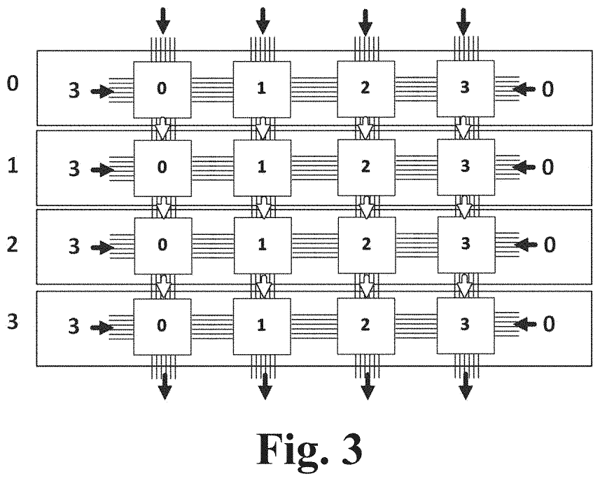

FIG. 3 There are 4 SiteOs in each row that are connected from left to right with the rightmost node connecting the leftmost one from right. The SiteOs in each row are connected vertically as well in columns. This configuration allows any of the 16 SiteOs to communicate with another. The communication can be parallel too; all 16 SiteOs can be communicating independently without requiring channel reservation.

The SiteOs are responsible for both computation and message passing. When a message arrives at SiteO, it first checks whether the destination of the message is its address, and if it matches, then the message is decoded and the instruction embedded within the message is executed, otherwise, the message is passed on.

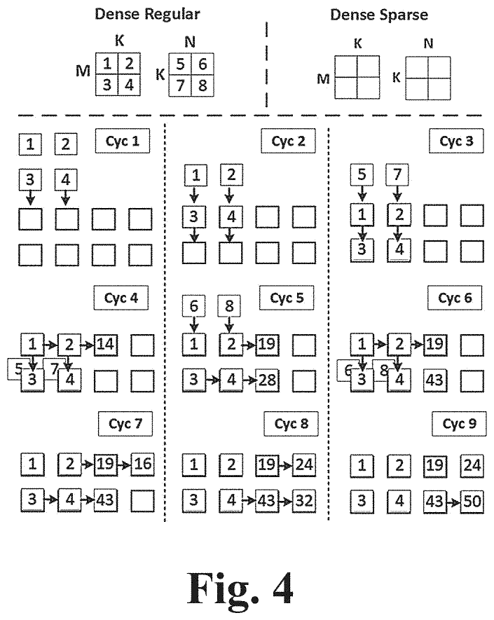

FIG. 4 To load a 2×2 matrix in 4 SiteOs, 4 messages need to be sent to those 4 specific SiteOs. The SiteOs are capable of basic arithmetic (e.g., addition, multiplication, subtraction) operations. They are aware of their neighbors (i.e., addresses of neighbor SiteOs in right, left, up, and down are stored in each SiteO). SiteOs also store a value and destination address to generate messages.

To illustrate SiteOs operations, let us take an example where multiplication steps are shown (A×B, A=[{1,2}, {3,4}] and B=[{5,6},{7,8}]). First, matrix A needs to be loaded as stationary. Values 1, 2, 3 and 4 values are encoded as messages and sent in batches (row 2 {3,4} first and followed by row 1 {1,2}). The SiteOs situated in the top row propagate messages containing values {3,4} downwards in the first cycle. If the messages are to be routed/passed downward, those messages are labeled as Tile message and if they are passed rightward (within the same SiteO row), those are labeled as Local messages.

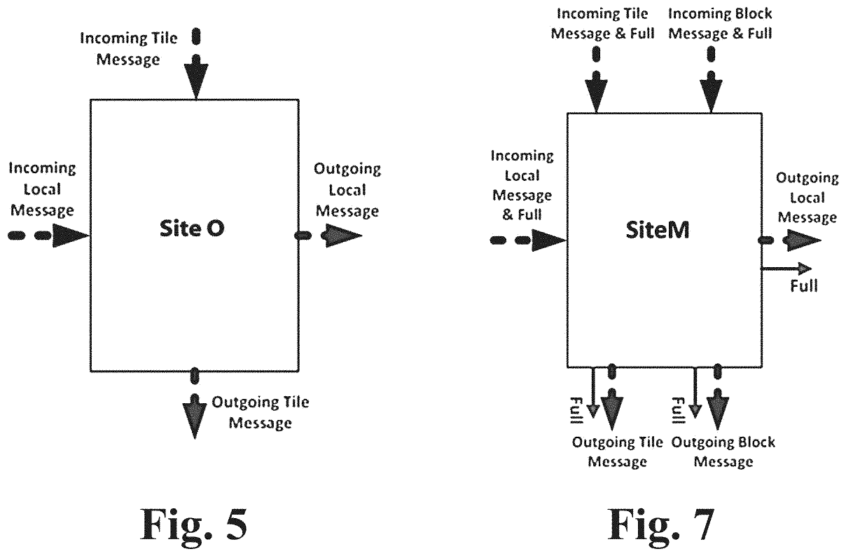

FIG. 5 The phase when stationary values are first loaded is called programming. To distinguish between programming and operation, the opcode values act as guides. For simplicity, 44 bit encoding is shown; it can be easily expanded for floating point operations with higher bitwidth.

As an example, the SiteO located in (0,0) position in the 16 site based tile organization receives a message whose opcode is PROGDS, 1 as value, ACCUMS as next opcode, and 2 as the next destination, which means this SiteO should store 1 as its stationary value, enable down stream flag to stream operands downwards and also store ACCUMS in the opcode field and 2 in the destination field for future messages originating from this SiteO. Streaming and message forwarding are two different tasks; in case of streaming, the SiteO receives the message sends it to its preferred neighbor by updating the message, whereas in forwarding, the SiteO behaves as a buffer to pass messages without intervention.

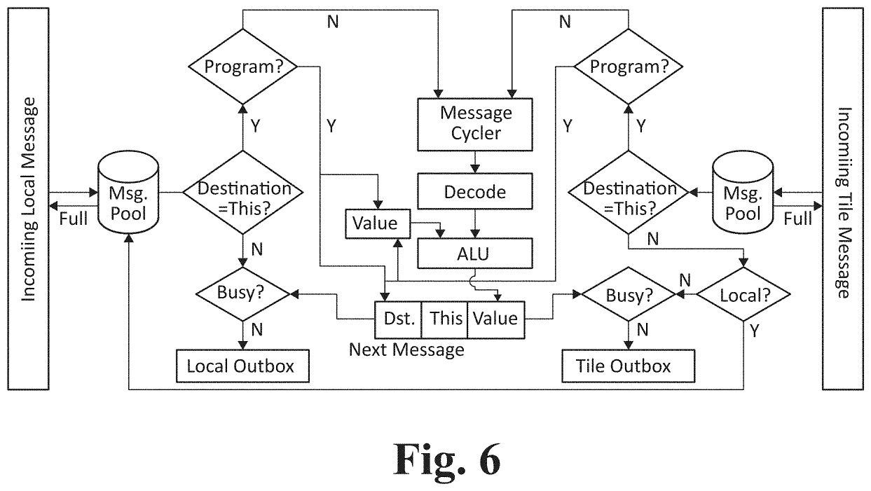

FIG. 6 There are 2 First In First Out (FIFOs) storage structures to store incoming messages and push them towards execution or exit route in a pipelined manner. If the FIFOs are empty, the turnout time for in and out for a message is 1 cycle. If multiple messages arrive at the same time for the same SiteO, we use a cycler circuit (cycles between messages) to handle one message at a time in the ALU.

The incoming messages are stored in message pools or FIFOs and then are fed to decode units. For the arrival of concurrent messages in the decode unit, a message cycler is used which funnels one message at a time. The SiteO also stores opcode and destination for a message that may originate from this SiteO.

Inputs and outputs of SiteO and internal constructions are shown on the right. The incoming messages are stored in message pools or FIFOs and then are fed to decode units. For the arrival of concurrent messages in the decode unit, a message cycler is used which funnels one message at a time. The SiteO also stores opcode and destination for a message that may originate from this SiteO.

FIG. 7 There are 4 SiteOs in each row that are connected from left to right with the rightmost node connecting the leftmost one from right. The SiteOs in each row are connected vertically as well in columns. This configuration allows any of the 16 SiteOs to communicate with another. The communication can be parallel too; all 16 SiteOs can be communicating independently without requiring channel reservation. In addition to the interconnection mechanism discussed earlier, each row of a Tile has a horizontal bus that is shared across Sites in the same column. The row and column buses facilitate further data transport without requiring hopping through Sites.

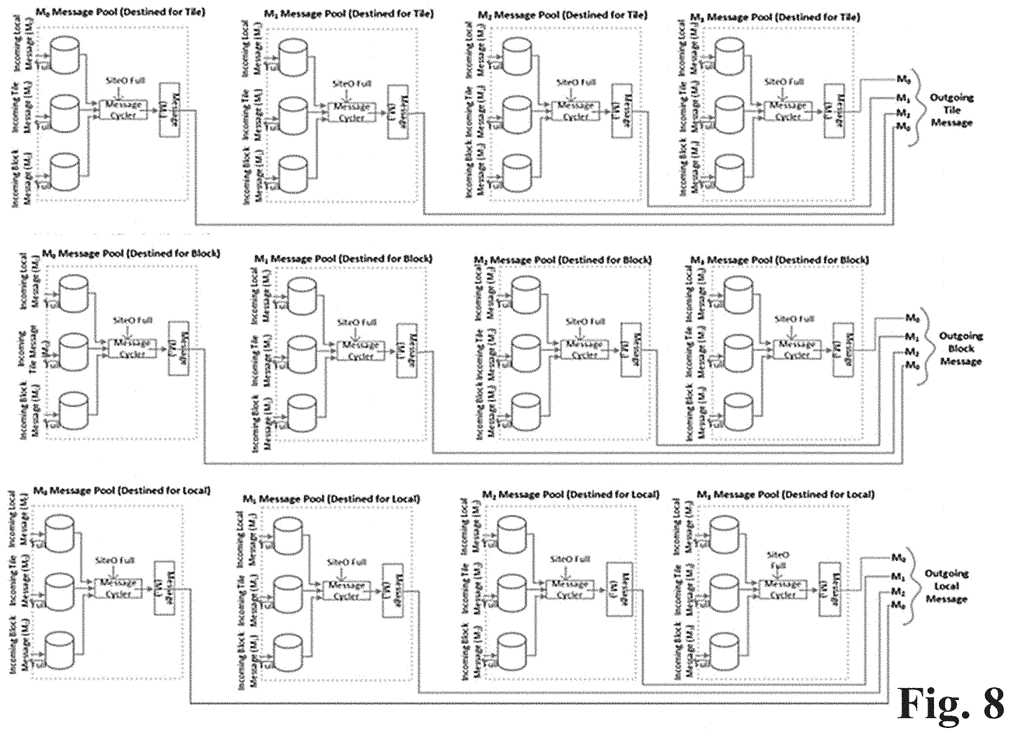

FIG. 8 The gateway to the tile is SiteM. A SiteM routes messages to their proper destination. Similar to SiteOs organization in a Tile (24), a collection of Tiles (24) is called Blocks (20). A Tile (24) can have messages destined to itself (i.e., coming from within the Tile (24) or outside the Tile (24), called Tile messages and also have incoming messages destined for other Tiles (24) within the same row (called Local messages with respect to Blocks (20)) and same column (called Block messages).

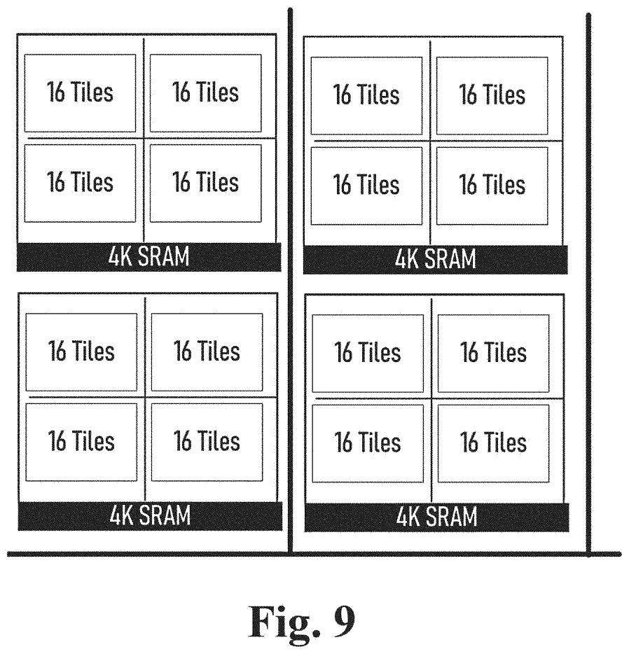

FIG. 9 Internals of the m-IPU engine with embedded memory interface is shown. Each Quad (16) is interfaced with embedded memory to take in both programming and data inputs.

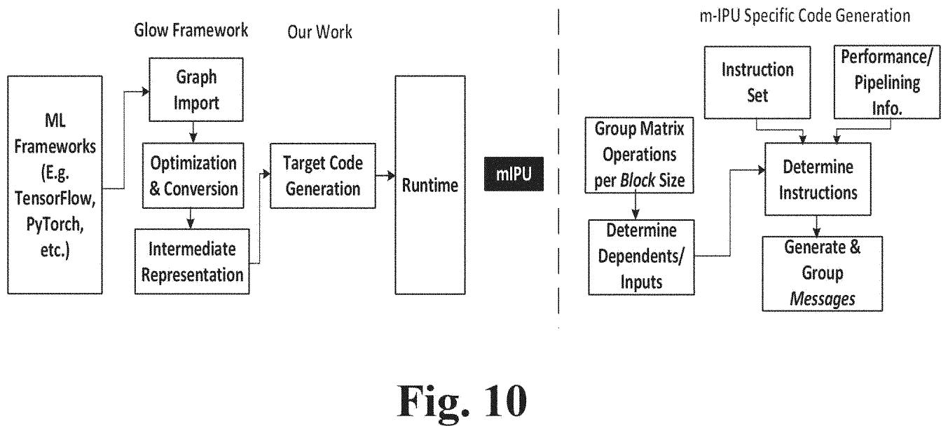

FIG. 10 shows compiler framework. The m-IPU specific code generation from high level framework like TensorFlow, PyTorch, is shown on the left. The right shows the proposed method for m-IPU specific instruction/message generation from the intermediate representation.

SiteM collects all these messages and outputs 12 messages (4 for its own Tile (24), 4 for other Tiles (24) (within the same row, and 4 for different columns/Blocks (20)) at a time. Similar to SiteO's cycler, a cycler circuit is used to select among different choices. The 4 Tile message outputs from SiteM are fed to 4 SiteOs simultaneously. Similar to SiteMs, BlockMs are gateways to Blocks (20) and can output 48 messages/cycle. 16 out of those 48 messages are intended for the same Block (20). A Block (20) is a collection of 256 SiteOs and 16 SiteMs. 4 Blocks (20) combined make a Quad (16). A Quad (16) has 1024 SiteOs. The Blocks (20) in a Quad (communicate through SuperBlocks. SuperBlocks have mailbox organization and allow point to point communication between Blocks (20).

A SiteM routes messages to their proper destination. Similar to SiteOs organization in a Tile (24), a collection of Tiles (24) is called Blocks (20). A Tile (24) can have messages destined to itself (i.e., coming from within the Tile (24) or outside the Tile (24)), called Tile messages and also have incoming messages destined for other Tiles (24) within the same row (called Local messages with respect to Blocks(20)) and same column (called Block messages).

The Gossip protocol is used to repair the problems caused by multicasting; it is a type of communication where a piece of information or gossip in this scenario, is sent from one or more nodes to a set of other nodes in a network. This is useful when a group of clients in the network require the same data at the same time. But there are many problems that occur during multicasting, if there are many nodes present at the recipient end, latency increases; the average time for a receiver to receive a multicast and latency is unwanted in computing processing.

To get this multicast message or gossip across the desired targets in the group, the gossip protocol sends out the gossip periodically to random nodes in the network, once a random node receives the gossip, it is said to be infected due to the gossip. In a manner similar to the way epidemics spread, the random node that receives the gossip does the same thing as the sender, it sends multiple copies of the gossip to random targets. This process continues until the target nodes get the multicast. When that occurs, and with reference to an epidemic, the process turns the “infected nodes” to “uninfected nodes” after sending the gossip out to random nodes.

Applicant's computer architecture can be applied to implement machine learning, artificial intelligence algorithms and FFPGAs. Central to the approach is the mimic of gossip behavior, where each person/entity talks to its neighbor and the message passes to the end through side talks instead of using direct communication.

1. A reconfigurable computer architecture, including:
a reconfigurable chip;
wherein nodes are interconnected using a virtual interconnection;
wherein each node stores a source address and a destination address;
wherein the nodes communicate with one another using message passing.

2. The reconfigurable computer architecture of claim 1, wherein the reconfigurable computer architecture includes a Probabilistic Magneto-Electric Computing framework.

3. The reconfigurable computer architecture of claim 1, wherein the reconfigurable computer architecture includes a Probabilistic Magneto-Electric Computing processor.

4. The reconfigurable computer architecture of claim 1, wherein the reconfigurable computer architecture facilitates segmentation of tasks to distributed parallel units.

5. The reconfigurable computer architecture of claim 1, wherein the reconfigurable computer architecture is reconfigurable at run-time.

6. The reconfigurable computer architecture of claim 1, wherein any computing core can be connected to another at run-time.

7. The reconfigurable computer architecture of claim 1, wherein the node corresponds to a Site.

8. The reconfigurable computer architecture of claim 1, wherein message passing corresponds to a gossip protocol, wherein messages are sent randomly to receiver nodes, wherein the receiver nodes then send the messages to other receiver nodes until a target node receives the message.
